(19) United States
(12) Patent Application Publication
(10) Pub. No.: US 2016/0063653 A1
(43) Pub. Date: Mar. 3, 2016

(54) IN-VEHICLE CONTENT SYSTEMS AND METHODS

(71) Applicant: NCR Corporation, Duluth, GA (US)

(72) Inventor: Robert Sutton, Cumming, GA (US)

(21) Appl. No.: 14/471,787

(22) Filed: Aug. 28, 2014

(51) Int. Cl. G06Q 50/14; G06Q 20/18; G06Q 20/12; G06Q 20/20

(52) U.S. Cl. CPC G06Q 50/14; G06Q 20/204; G06Q 20/18; G06Q 20/123

(57) ABSTRACT

Various embodiments herein each include at least one of systems, methods, and software for in-vehicle content systems and methods. One method embodiment includes retrieving passenger manifest data of a transportation service segment. The passenger manifest data may include a plurality of passenger profile identifiers and assigned seat numbers associated with at least some of the passenger profile identifiers. The method may then retrieve passenger profile data based on at least some of the passenger profile identifiers included in the passenger manifest data and provide the retrieved passenger profile data and the retrieved passenger manifest data to a data storage and processing system of a vehicle assigned to service the transportation service segment. Such methods may be performed during pre-segment preparation of the vehicle, during a prior segment, or during the segment.

### BACKGROUND INFORMATION

Travelers today are demanding greater connectivity and access to content every day. At the same time, the airline industry is very competitive, so much so that profit of some airlines is driven more from sales of ancillary products and services than the air travel tickets themselves. Thus, providing the connectivity and content access that travelers desire while traveling with an airline while also maximizing revenue opportunities of the airline have become driving factors in the airline industry.

### SUMMARY

Various embodiments herein each include at least one of systems, methods, and software for in-vehicle content systems and methods.

One method embodiment includes retrieving passenger manifest data of a transportation service segment. The passenger manifest data may include a plurality of passenger profile identifiers and assigned seat numbers associated with at least some of the passenger profile identifiers. The method may then retrieve passenger profile data based on at least some of the passenger profile identifiers included in the passenger manifest data and provide the retrieved passenger profile data and the retrieved passenger manifest data to a data storage and processing system of a vehicle assigned to service the transportation service segment. Such methods may be performed during pre-segment preparation of the vehicle, during a prior segment, or during the segment.

Another embodiment is an in-vehicle data storage and processing system. The in-vehicle data storage and processing system includes at least one network interface device, at least one processor, and at least one data storage device. The at least one data storage device stores instructions executable by the at least one processor to perform data processing activities. The data processing activities include receiving, via the at least one network interface device, and storing, on the at least one data storage device, passenger manifest and profile data with regard to a transportation service segment of a vehicle in which the in-vehicle data storage and processing system is deployed. The data processing activities of some embodiments further include retrieving passenger identifying data and data representative of respective passenger seat assignments from at least one of the passenger manifest data and passenger profile data stored on the at least one data storage device. The data processing activities may also include transmitting passenger identifying data to each of a plurality of in-vehicle content presentation devices associated with seats assigned to respective passengers, the passenger identifying data transmitted via the at least one network interface device to the respective in-vehicle content presentation devices to be presented thereon.

Another embodiment is at least one data storage device that stores instructions executable by at least one processor to perform data processing activities. The data processing activities of such embodiments include receiving, via at least one network interface device, and storing, on the at least one data storage device, passenger manifest and profile data with regard to a transportation service segment of a vehicle in which an in-vehicle data storage and processing system is deployed. The passenger manifest data and passenger profile data may include data identifying points of travel departure and destination of passengers. The data processing activities of such embodiments further include retrieving and transmitting passenger identifying data to each of a plurality of in-vehicle content presentation devices associated with seats assigned to respective passengers, the passenger identifying data transmitted via the at least one network interface device to the respective in-vehicle content presentation devices to be presented thereon.

### BRIEF DESCRIPTION OF THE DRAWINGS

FIG. 1 is a block diagram of a system including an in-vehicle content system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, methods, and software for in-vehicle content systems and methods. Some such embodiments are integrated platforms for delivery of goods, services, entertainment, customer service, and communication. Some such embodiments may operate in an integrated manner with other systems, such as travel reservation systems and online marketplaces for purchases of goods for delivery aboard a vehicle (e.g., airplane, train, bus, van, ship, etc.), upon disembarking a vehicle, or other time and location. Embodiments are typically built upon a distributed system architecture. Such a system architecture may include one or more servers of a travel service company, such as an airline, connected to servers of one or more other entities. This architecture brings together content, product and service offerings, and other data and delivers it to various access points for access by passengers, staff, and others that may be present at an access point. At the same time, activities of access point users may be monitored, recorded, or otherwise tracked in a manner that provides insight into user preferences, dislikes, lifestyle, demographic characteristics, familial composition, likely purchases, and the like. Through these various embodiments, passengers are provided the access and connectivity they desire and the travel service company, such as an airline, rail operator, or coach operator, has new distribution channels for information and marketing, a sales driver and facilitator, new point-of-sale outlets, advertising distribution outlet, and revenue sources.

The access points of various embodiments may include in-vehicle content presentation devices, such as airplane, train, coach, and automobile seat entertainment devices that may be integrated into a headrest or bulkhead in front of a seat or otherwise integrated in a passenger compartment. In some embodiments, the access point may be a computing device, such as a tablet, other mobile device-type, or personal computer provided to or brought by passengers. In some of these embodiments, other access points may be present, such as kiosks in boarding, ticketing, baggage checking and pickup, and other terminal areas. Such kiosks may be dual purpose, such as a boarding pass kiosk as are commonly found in modern airline ticketing areas that may also be an access point. In some embodiments, an access point may provide access to travel information, frequent traveler program accounts, content such as movies and television shows, listings of products and services for sale, news, and games, among other content.

Content available on an access point may be determined by a travel operator or one or more of their business partners. Content may also be determined based on a user of the access point. For example, a user, such as a travel service passenger may have a profile account with the travel operator, such as a frequent flyer account, that may be accessed online by the user. The user may select or purchase content in advance of a travel segment, such as a movie the user desires to watch. The selected or purchased content will then be available on an access point of the user at least during a particular segment or for a period for which a purchase may allow access. Access to the content may be provided via a network in some embodiments. However, some embodiments include distributing content selected or purchased in advance of a travel to a data storage and processing system of a vehicle assigned to service the particular transportation service segment. The data storage and processing system may then provide the content to the user while aboard the vehicle for the travel segment. The data storage and processing system of the vehicle may also store other content that is generally available or available to only certain passenger users, such as by their identities, qualification level in a loyalty program, class of service, age, spoken language(s), and the like.

Some embodiments may also include leveraging onboard access points to welcome passengers, inform or remind them of their seat assignments, present menus, local or destination weather during a boarding process, and the like.

The embodiments herein provide for rich, tailored, connected travel experiences that enhance opportunities for travel service operators. These and other embodiments are described below with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, Application Integrated Circuit (ASIC), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

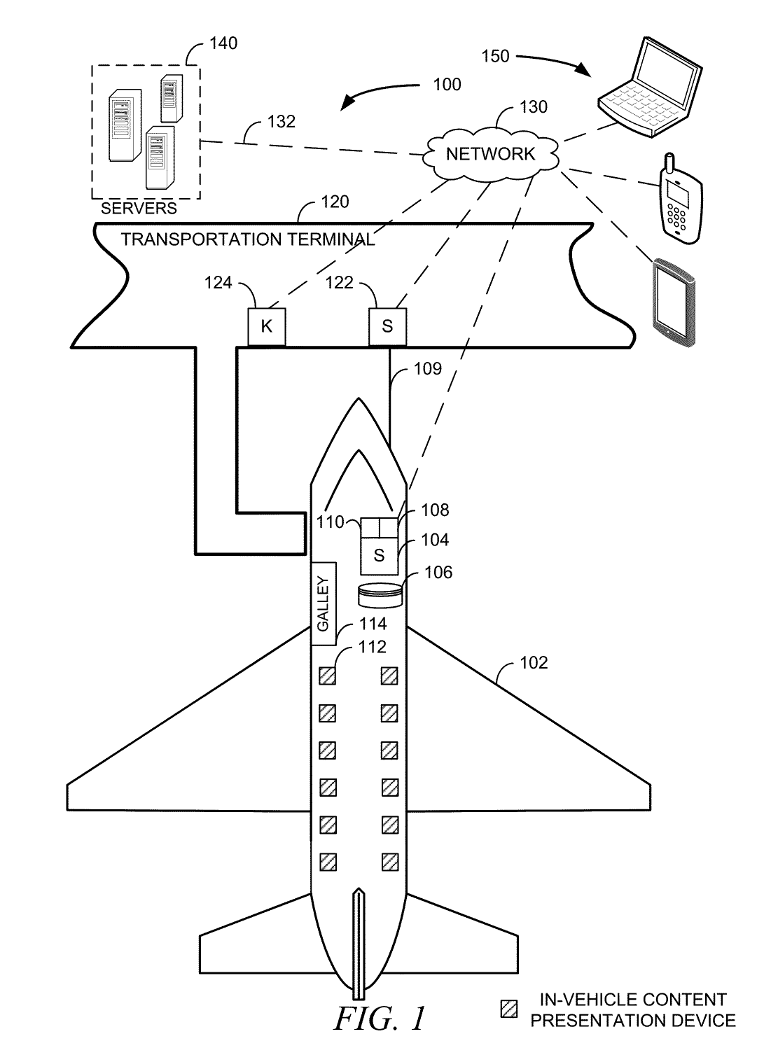

FIG. 1 is a block diagram of a system 100 including an in-vehicle content system, according to an example embodiment. The system 100 may be deployed to provide to provide travel service passenger rich, tailored, connected travel experiences that enhance opportunities for travel service operators in terms of both customer loyalty and revenue.

At the core of these embodiments is of course a vehicle. The vehicle may be an airplane 102 as illustrated in FIG. 1. However, the actual vehicle-type may vary between embodiments as not only airplanes 102 may be outfitted as illustrated and described herein. For example, the system 100 may be equally fitted to other vehicle types, such as trains, coaches, cruise ships, ferries, vans, automobiles. Thus, although many of the embodiments herein are described an illustrated with regard to the airplane 102, this is provided merely as an example and is not intended to limit the scope of the embodiments described herein and as set forth in the subjoined claims.

The airplane 102 is fitted with a server 104 computing device that includes data storage 106, also referred to as data storage and processing system or onboard data storage and processing system. The server 104 and storage 106 may be implemented for onboard content delivery purposes among one or many other purposes related to operation of the subject vehicle, such as the airplane 102. In the content delivery context, the server 104 and storage 106 operate to receive and retrieve content for provisioning to in-vehicle content presentation devices, such as in-vehicle content presentation device 112, such as over a wired or wireless network, such as via an onboard network interface device 110. The onboard network interface device may include one or more of an Ethernet device, one or more wired or wireless routers and network switches, and other networking devices coupled to the server 104.

Content may be retrieved and/or received by the server 104 and storage 106 via a network interface device 108 or other data interconnection over which data communication may be established (e.g., high-speed Universal Serial Bus (USB) and other such data interconnection solutions). For example, the network interface device 108 may be a wired or wireless network interface device 108 that enables data communication of the server 104 over a network 130, such as one or both of satellite and terrestrial data networks that may provide Internet or other network communication capabilities. In these and other embodiments, the network interface device 108 may also, or alternatively, include a cable-based interconnection, such as by airplane 102 wired connection 109 to a server 122 located in or proximate to a transportation terminal 120 from which passengers may board the airplane 102, or other vehicle-type. Regardless of connectivity utilized, the server 104 receives or retrieves content via the connection and stores it in the storage 106 for delivery to the in-vehicle content presentation devices.

Content received or retrieved by the server 104 and storage 106 may be sourced from one or more servers 140. The servers 104 also communicate data on the network 130. The servers 140 may include a server from which travel segment manifest data and passenger profile data may be obtained, such as a server that may be operated by a travel service provider (e.g., airline, cruise line, rail operator, coach operator). The servers 140 may also include one or more content servers from which content may be retrieved. A content server may be operated by the travel service provider. However, in some embodiments, content servers, may also or alternatively, be operated by one or more of content developers (e.g., media companies, movie and television production companies, advertisement distributors, advertisement companies, news and weather outlets, music producers, and marketers of content of these entity types).

The content received or retrieved by the server 104 and storage 106, as discussed, is sourced from the one or more servers 140. In some embodiments, the content received or retrieved may be sourced directly, over the network 130, from the one or more servers 140. However, in some embodiments, a server 140 process may execute to retrieve and pre-stage the content for delivery to or retrieval by the server 104 and storage 106. This pre-staging of content may be performed to lessen an amount of time load the data into the storage 106 while a vehicle is at a terminal 120 between travel segments. The content in such embodiments may be assembled and pre-staged by storing the data to a server 122 located at the terminal 120 or other location that will provide data to the server 104 and storage 106 at a relatively quick speed. In some other embodiments, the data may be pre-staged to a portable data storage device that may be coupled to the server 104 for use during a travel segment as storage 106 or from which the content may be loaded to the storage 106.

In some embodiments, the content received or retrieved by the server 104 and storage 106 may include products offered for sale or as offered and included in the travel service. The products may be products offered for sale aboard the vehicle, such as duty-free items offered for sale aboard the airplane 102. The products may also include products offered for sale that may be delivered upon arrival at a destination or for delivery to a supplied address.

Content that is received or retrieved by the server 104 and storage 106 may be simply defined by the operating travel service provider, such as according to a defined schedule of programming and content availability. However, some embodiments include mechanisms whereby content available to passengers can be customized based on an array of factors. One set of these factors may be with regard to a travel segment, such as departure and destination cities. News, weather, and attraction related content may be selected for availability on the server 104 and storage 106 based thereon. Another set of factors may be based on profile data of ticketed passengers, such as may be available in a frequent traveler profile. Such profile data may include a home address. News and weather content may be retrieved based thereon.

However, some embodiments identify content using this data through more sophisticated processes that may execute on one or more servers 140. This profile data, which may include not only passenger supplied data but also data representative of passenger history with the travel services operator as may be augmented with individual-specific data available from other sources, may provide great insight into the person, their preferences and dislikes, income level, net worth, familial composition, and perhaps even a favorite color. Such data may be utilized in some embodiments to intelligently select content that to be loaded on or otherwise be made available to passengers via access points, and in particular, via in-vehicle content presentation devices. As this data from which content may be selected included passenger-specific profile data, and as discuss below, content access points may be associated with specific passengers, passengers may be provided with content specifically selected for them. Such embodiments provide for content experiences that passenger-specific to not only enhance the passenger's travel experience, but to also facilitate high-value marketing opportunities for advertisement delivery.

The content received or retrieved by the server 104 and storage 106 in some embodiments may also include content purchased or rented by a passenger for delivery to the specific passenger. The purchased or rented content may have been procured by the passenger during a previous travel segment. However, content may also be offered for purchase or rent via other channels, such as within a travel loyalty program website, a purchase or subscription-based content service of another entity, and the like. The general notion of such embodiments is that content previously purchased by a passenger, as may be associated in some manner with a profile of the passenger, may be selected for receipt or retrieval based on a passenger action indicating a desire for the content to be available during a travel segment for access on an in-vehicle content presentation device. Thus, not only may content be provided that a passenger is likely interested in, but access can also be provided to content the passenger orders.

The in-vehicle content presentation devices, such as in-vehicle content presentation device 112, are access points as described above. The in-vehicle content presentation devices may take various forms in different embodiments and may actually take a plurality of these forms in a single embodiment. The forms of the in-vehicle content presentation devices may include seat-based content access entertainment devices or terminals that may be integrated into a headrest or bulkhead in front of a seat or otherwise be integrated in a passenger compartment as have started becoming common on modern aircraft, especially aircraft that service long-haul flights.

The forms of the in-vehicle content presentation devices may also include mobile devices, such as tablets and smartphones, as well as personal computers such as laptops. The mobile devices and personal computers may be provided to passengers by an operator of the vehicle, but may also be brought aboard by passengers.

In some other embodiments, the in-vehicle content presentation devices may include displays and interactive devices deployed throughout the vehicle. For example, a galley 114 area of the airplane 102 may include one or more displays on which a menu of food and beverage options may be presented based on data from the server 104 and storage 106. Further, vehicles such as the airplane 102 include seats organized in rows of seats having letters or numbers. Labels affixed in certain locations conventionally provide seat identifying information. In some embodiments, these labels may be replaced or augmented with displays on which passenger identifying data may be presented, thereby assisting passengers during a boarding process, helping passengers feel more valued, and assisting attendant personnel in referring to passengers by name.

Regardless of the device form of the in-vehicle content presentation device, these devices may access or receive content from the server 104 and storage 106. The in-vehicle content presentation devices may access stored content via a browser-based delivery system that executes at least in part on the server 104 or as may be facilitated by an app or application installed or otherwise execute on the particular device. In some embodiments, a device may be controlled by a process that executes on the server 104, such as the seat label displays discussed in the preceding paragraph.

In some embodiments, an in-vehicle content presentation device may include one or more payment modules. A payment module may be a bankcard-reading device, such as may be utilized to read one or more of credit and debit card magnetic stripes and embedded chips. The payment module may also, or alternatively, include software of a digital wallet account service, such as may be associated with a passenger profile. The digital wallet account service may include an online payment account option, such as may be integrated with payment services provided by PAYPAL® or other payment service provider. These and other embodiments may include other hardware and software that may be utilized to make payments.

Regardless of the forms or technical modes of payment that may be accepted via an in-vehicle content presentation device, payments may be received with regard to products and services presented in content available on or via the in-vehicle content presentation device. Items available for purchase may be provided via digital catalog content, interactive advertisements, food and beverage menus, and the like.

In some embodiments, the system 100 may also include additional access points. The additional access points may include one or more kiosks 124 located in a boarding area of a terminal 120, ticketing area, and may include passenger mobile devices 150.

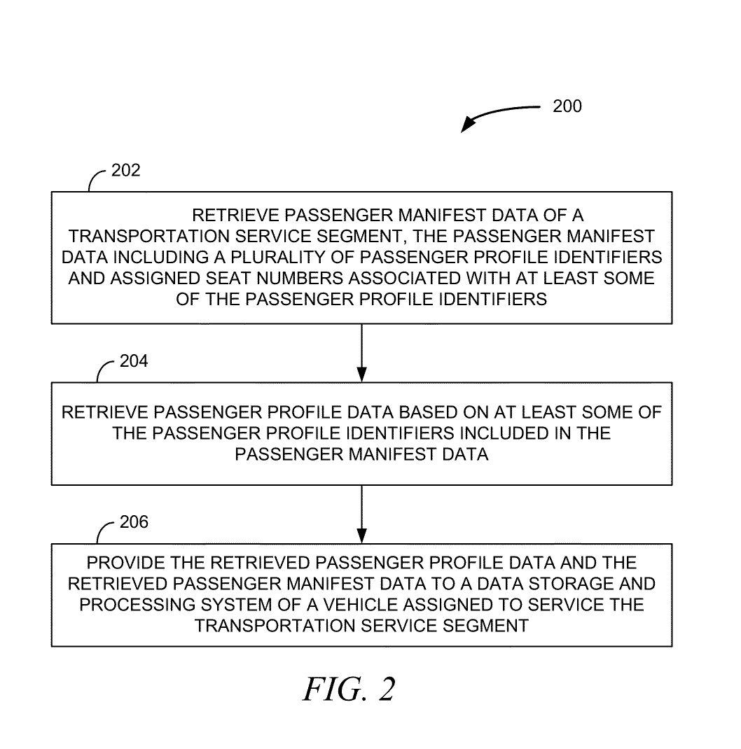

FIG. 2 is a block flow diagram of a method 200, according to an example embodiment. The method 200 is an example of a method that may be performed in some embodiments to identify, gather, and load content to the server 104 and storage 106 of a vehicle, such as airplane 102 of FIG. 1.

The method 200 includes retrieving 202 passenger manifest data of a transportation service segment. The passenger manifest data typically includes a plurality of passenger profile identifiers and assigned seat numbers associated with at least some of the passenger profile identifiers. The method 200 then retrieves 204 passenger profile data based on at least some of the passenger profile identifiers included in the passenger manifest data. The retrieved passenger profile data and the retrieved passenger manifest data may then be provided 206 to a data storage and processing system of a vehicle assigned to service the transportation service segment.

In some embodiments of the method 200, the data storage and processing system of a vehicle assigned to service the transportation service segment is a data storage and processing system located on the vehicle assigned to service the transportation segment.

In some embodiments, the method 200 is performed at least in part by the data storage and processing system of the vehicle assigned to service the transportation service segment.

The method 200, in some embodiments, further includes retrieving passenger identifying data and data representative of respective passenger seat assignments from at least one of the passenger manifest data and passenger profile data from the data storage and processing system. Based on this data, the method may then transmit passenger-identifying data to each of a plurality of in-vehicle content presentation devices associated with seats assigned to respective passenger for presentation of the data thereon.

In another embodiment of the method 200, the passenger profile data of a first passenger includes data representative of at least one preference of the first passenger. Based at least in part on the at least one passenger preference, such embodiments may further include retrieving a content item from a content repository and providing the retrieved content item and association of the retrieved content item to the passenger profile data of the first passenger to the data storage and processing system. In some embodiments of the method, the retrieving of the content item from the content repository is performed while the vehicle is in route, such as may be retrieved from the vehicle via a satellite or terrestrial-based network via a network interface device 108 of FIG. 1.

Continuing with this embodiment, the first passenger will then be presented with an option to view the content item via an in-vehicle content presentation device. The content item in such embodiments may be an interactive content item retrieved based on a determined likelihood of interest by the first passenger determined based at least in part on the at least one preference. Another selected content item may be an interactive catalog of products offered for sale that are selectable for purchase when presented on the in-vehicle content presentation device that may be paid for via the in-vehicle content presentation device.

In another embodiment of the method 200, the passenger manifest data and passenger profile data includes data identifying points of travel departure and destination of passengers. In this embodiment, the method 200 further includes retrieving a plurality of content items from a content repository based at least in part on the points of travel departure and destination of passengers. The retrieved content items are then on the data storage and processing system such that passengers will be presented with options to view the content items via in-vehicle content presentation devices.

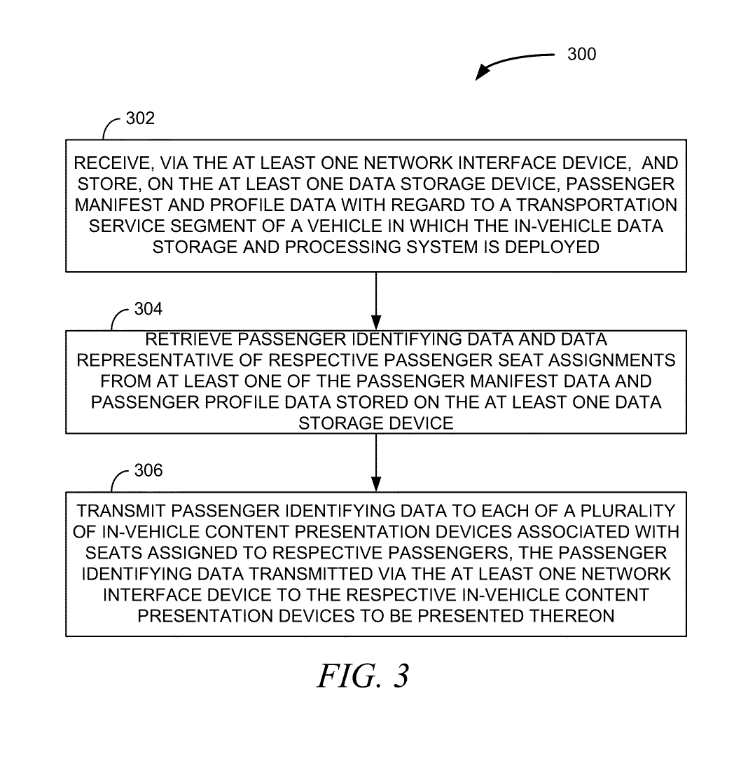

FIG. 3 is a block flow diagram of a method 300, according to an example embodiment. The method 300 is an example of a method that may be performed by on-vehicle the server 104 of FIG. 1. The method 300 includes receiving 302 and storing passenger manifest and profile data with regard to a transportation service segment of a vehicle in which the in-vehicle data storage and processing system is deployed. The method 300 further includes retrieving 304 passenger identifying data and data representative of respective passenger seat assignments from at least one of the passenger manifest data and passenger profile data stored. The method 300 may then transmit 306 passenger identifying data to each of a plurality of in-vehicle content presentation devices associated with seats assigned to respective passengers for presentation thereon.

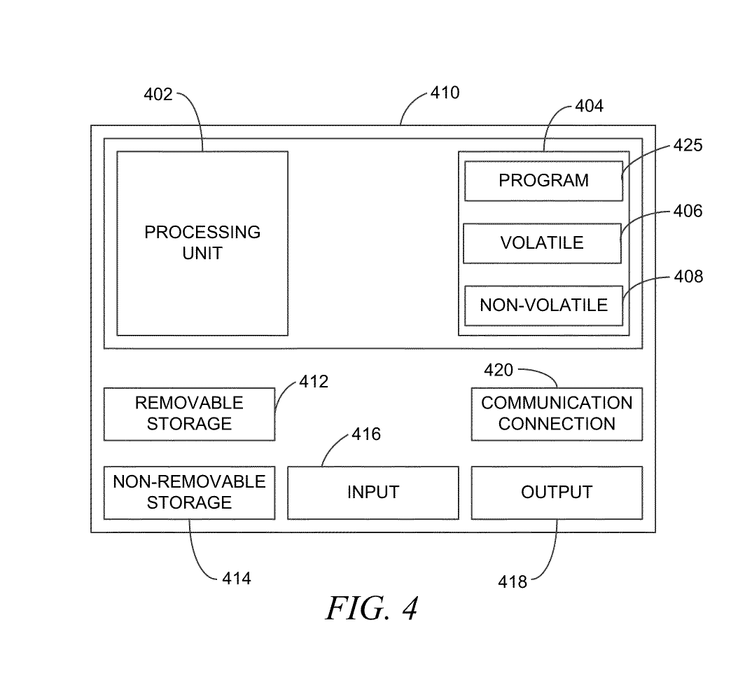

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may implement such functions and communicate between the multiple systems and components. One example computing device in the form of a computer 410, may include a processing unit 402, memory 404, removable storage 412, and non-removable storage 414. Although the example computing device is illustrated and described as computer 410, the computing device may be in different forms in different embodiments. For example, the computing device may instead be an in-vehicle content presentation device, smartphone, a tablet, or other computing device including the same or similar elements as illustrated and described with regard to FIG. 4. Further, although the various data storage elements are illustrated as part of the computer 410, the storage may also, or alternatively, include cloud-based storage accessible via a network, such as the Internet.

Returning to the computer 410, memory 404 may include volatile memory 406 and non-volatile memory 408. Computer 410 may include—or have access to a computing environment that includes a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 410 may include or have access to a computing environment that includes input 416, output 418, and a communication connection 420. The input 416 may include one or more of a touchscreen, touchpad, mouse, keyboard, camera, and other input devices. The computer may operate in a networked environment using a communication connection 420 to connect to one or more remote computers, such as database servers, web servers, and other computing device. An example remote computer may include a personal computer (PC), server, router, network PC, a peer device or other common network node, or the like. The communication connection 420 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 402 of the computer 410. A hard drive (magnetic disk or solid state), CD-ROM, and RAM are some examples of articles including a non-transitory computer-readable medium. For example, various computer programs 425 or apps, such as one or more applications and modules implementing one or more of the methods illustrated and described herein or an app or application that executes on a mobile device or is accessible via a web browser, may be stored on a non-transitory computer-readable medium.

Another embodiment is an in-vehicle data storage and processing system, such as the server 104 and storage 106 deployed on the airplane 102 of FIG. 1. The in-vehicle data storage and processing system of such embodiments includes at least one network interface device, at least one processor, and at least one data storage device. The at least one data storage device stores instructions executable by the at least one processor to perform data processing activities. Such data processing activities may include receiving, via the at least one network interface device, and storing, on the at least one data storage device, passenger manifest and profile data with regard to a transportation service segment of a vehicle in which the in-vehicle data storage and processing system is deployed. The data processing activities may further include retrieving passenger identifying data and data representative of respective passenger seat assignments from at least one of the passenger manifest data and passenger profile data stored on the at least one data storage device. The data processing activities may also include transmitting passenger identifying data to each of a plurality of in-vehicle content presentation devices associated with seats assigned to respective passengers, the passenger identifying data transmitted via the at least one network interface device to the respective in-vehicle content presentation devices to be presented thereon. Some such embodiments are operable to provide passenger-specific, tailored content experiences.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method comprising:
retrieving passenger manifest data of a transportation service segment, the passenger manifest data including a plurality of passenger profile identifiers and assigned seat numbers associated with at least some of the passenger profile identifiers;
retrieving passenger profile data based on at least some of the passenger profile identifiers included in the passenger manifest data, the passenger profile data of a first passenger including data representative of at least one preference of the first passenger;
retrieving a content item from a content repository based at least in part on the at least one preference of the first passenger profile data; and
storing the retrieved passenger profile data, the retrieved passenger manifest data, and the retrieved content item to a data storage device of a data storage and processing system of a vehicle assigned to service the transportation service segment.

2. The method of claim 1, wherein the data storage and processing system of a vehicle assigned to service the transportation service segment is a data storage and processing system located on the vehicle assigned to service the transportation segment.

3. The method of claim 1, wherein:
the method is performed at least in part by the data storage and processing system of the vehicle assigned to service the transportation service segment; and
the method further comprising:
retrieving passenger identifying data and data representative of respective passenger seat assignments from at least one of the passenger manifest data and passenger profile data from the data storage and processing system; and
transmitting passenger identifying data to each of a plurality of in-vehicle content presentation devices associated with seats assigned to respective passengers, the passenger identifying data transmitted to the respective in-vehicle content presentation devices to be presented thereon.

4. The method of claim 1, further comprising:
providing the first passenger with an option to view the content item via an in-vehicle content presentation device of the vehicle assigned to service the first passenger during the transportation segment.

5. The method of claim 4, wherein the content item is an interactive content item retrieved based on a determined likelihood of interest by the first passenger, the likelihood determined based at least in part on the at least one preference.

6. The method of claim 4, wherein the content item is an interactive catalog of products offered for sale, the products of which are selectable for purchase when presented on the vehicle content presentation device, a payment for purchase of a selected product receivable via a card reader of the vehicle content presentation device.

7. The method of claim 4, wherein the retrieving of the content item from the content repository is performed while the vehicle assigned to service the transportation service segment is in route.

8. The method of claim 1, wherein the passenger manifest data and passenger profile data includes data identifying points of travel departure and destination of passengers, the method further comprising:
retrieving a plurality of content items from a content repository based at least in part on the points of travel departure and destination of passengers; and
storing the retrieved content items on the data storage and processing system such that passengers will be presented with options to view the content items via in-vehicle content presentation devices.

9. An in-vehicle data storage and processing system comprising:
at least one network interface device; and
at least one processor and at least one data storage device, the at least one data storage device storing instructions executable by the at least one processor to perform data processing activities comprising:
receiving, via the at least one network interface device, and storing, on the at least one data storage device, passenger manifest and profile data with regard to a transportation service segment of a vehicle in which the in-vehicle data storage and processing system is deployed, the passenger profile data of a first passenger including data representative of at least one preference of the first passenger;
retrieving passenger identifying data and data representative of respective passenger seat assignments from at least one of the passenger manifest data and passenger profile data stored on the at least one data storage device;
retrieving a content item from a content repository based at least in part on the at least one preference of the first passenger profile data;
storing the retrieved content item on the at least one data storage device such that the first passenger will be presented with an option to view the content item via an in-vehicle content presentation device; and
transmitting passenger identifying data to each of a plurality of in-vehicle content presentation devices associated with seats assigned to respective passengers, the passenger identifying data transmitted via the at least one network interface device to the respective in-vehicle content presentation devices to be presented thereon.

10. (canceled)

11. The in-vehicle data storage and processing system of claim 9, wherein the content item is an interactive content item retrieved based on a determined likelihood of interest by the first passenger.

12. The in-vehicle data storage and processing system of claim 9, wherein the content item is an interactive catalog of products offered for sale, the products of which are selectable for purchase when presented on the vehicle content presentation device.

13. The in-vehicle data storage and processing system of claim 9, wherein the retrieving of the content item from the content repository is performed while the vehicle in which the in-vehicle data storage and processing system is deployed is in route.

14. The in-vehicle data storage and processing system of claim 9, wherein the passenger manifest data and passenger profile data includes data identifying points of travel departure and destination of passengers, the data processing activities further comprising:
retrieving a plurality of content items from a content repository based at least in part on the points of travel departure and destination of passengers; and
storing the retrieved content items on the data storage and processing system such that passengers will be presented with options to view the content items via in-vehicle content presentation devices.

15. At least one data storage device storing instructions executable by at least one processor to perform data processing activities comprising:
receiving, via at least one network interface device, and storing, on the at least one data storage device, passenger manifest and profile data with regard to a transportation service segment of a vehicle in which an in-vehicle data storage and processing system is deployed, the passenger manifest data and passenger profile data including data identifying points of travel departure and destination of passengers, the passenger profile data of a first passenger including data representative of at least one preference of the first passenger;
retrieving, via the at least one network interface device, and storing, on the at least one data storage device a content item from a remote content repository, the retrieving based at least in part on the at least one preference; and
retrieving and transmitting passenger identifying data to each of a plurality of in-vehicle content presentation devices associated with seats assigned to respective passengers, the passenger identifying data transmitted via the at least one network interface device to the respective in-vehicle content presentation devices to be presented thereon.

16. The at least one data storage device of claim 15, the data processing activities further comprising:
retrieving a plurality of content items from a content repository based at least in part on the points of travel departure and destination of passengers; and
storing the retrieved content items on the at least one data storage device such that passengers will be presented with options to view the content items via in-vehicle content presentation devices.

17. The at least one data storage device of claim 15, wherein the
storing of the retrieved content item and association of the retrieved content item to the passenger profile data of the first passenger on the at least one data storage device is performed such that the first passenger will be presented with an option to view the content item via the in-vehicle content presentation device.

18. The at least one data storage device of claim 17, wherein the content item is an interactive content item retrieved based on a determined likelihood of interest by the first passenger.

19. at least one data storage device of claim 17, wherein the content item is an interactive catalog of products offered for sale, the products of which are selectable for purchase when presented on the vehicle content presentation device.

20. The at least one data storage device of claim 17, wherein the retrieving of the content item from the content repository is performed while the vehicle in which the in-vehicle data storage and processing system is deployed is in route.
